(19) United States
(12) Patent Application Publication
(10) Pub. No.: US 2006/0178902 A1
(43) Pub. Date: Aug. 10, 2006

(54) Method and system for documenting assets with certified digital imager

(76) Inventors: Erik Vicars, Austin, TX (US); Fred R. Bickerstaff, Austin, TX (US); Rick B. Yeager, Austin, TX (US)

Correspondence Address: Rick B. Yeager, 10805 mellow Lane, Austin, TX, 78759, US

(21) Appl. No.: 11/330,979

(22) Filed: Jan. 12, 2006

Related U.S. Application Data
(60) Provisional application No. 60/643,298, filed on Jan. 12, 2005.

(51) Int. Cl. G06Q 99/00

(52) U.S. Cl. 705/1

(57) ABSTRACT

A home or small business inventory is documented by acquiring and processing a set of digital images. The processing includes sequencing and categorizing the images in a useful manner; associating receipts, audio testimony, video testimony, or other related information to the images; and providing a tamper-evident certification for the set of images. The certification includes visible watermarks, invisible watermarks and other security features. The images may be acquired by on on-site technician, or may be provided by electronic communication. A special collection device may be used to provide a certification that images were acquired at a specific time and place. The processed images may be provided on DVD or electronic files, and the inventory may be updated by supplemental DVD or file.

This is a non-provisional patent application which claims the benefit of U.S. Provisional Application No. 60/643298 filed Jan. 12, 2005 by applicant Erik Vicars.

### FIELD OF INVENTION

The current invention provides a method, an apparatus, and a system of providing certified digital images to document the inventory of items in a home or small business.

### BACKGROUND AND PRIOR ART

There is a need for improved methods of selecting proper insurance coverage based on the type and value of items owned by individuals or small business. There is also a need for more efficient and verifiable methods for preparing and processing insurance loss claims.

Digital images in the form of still photographs or videos would be useful in documenting an inventory of items, but those digital images could be fraudulently altered or edited. There is a need for providing a system and method for providing a conveniently sequenced or categorized set of tamper-evident images to document an inventory at a particular time.

Prior Art—Determination of Proper Insurance Coverage

A typical homeowner or condominium unit owner may make an application for insurance of personal property as part of a property insurance application.

The insurance application typically includes endorsements or options related to personal property which includes an election of type of replacement coverage, and special endorsements.

The options for replacement coverage typically include a range of possible recovery values. The insured value may represent actual replacement costs, current market value, or depreciated costs, which would reflect time of ownership or actual wear and tear of an item.

Special endorsements are typically required for many types of property, including business property, either on-site or offsite; firearms, home computers, incidental business property, jewelry, furs, art collections, and silverware/goldware. Examples of a need for an approximate cost for appropriate insurance coverage is computer (hardware and software), incidental business property, jewelry, furs, art collections, other collections, musical instruments, electronics (tapes, records, CDs, DVDs), cameras, sports equipment and personal tools.

There is a need for an insured to be able to make an informed decision on the type and amount of insurance coverage. A thorough inventory and appraisal can assist the insured in making that informed decision on the amount of insurance coverage. The inventory can also be used to show that a requested amount of coverage was reasonable, and was not an inflated value deliberately made in order to later file an exaggerated loss claim.

Prior Art—Inventory and Loss Claims

FIG. 1A is an example of a claim form 50, which is typically completed by the insured party and an insurance claim representative in the event of a loss. Typical losses include theft, fire, natural disasters or flood damage.

In this prior art example, the form includes a row of each item number 51, a short description of the property 52, and an entry for where the item was obtained 53.

FIG 1B shows an example of a partially completed prior art claim form. The claim representative determines a value for the item, such as an estimated or appraised replacement cost 60 for the item, and then determines a depreciative or discounted amount 61 to apply to the item.

In one embodiment of the current invention a digital image inventory is available to assist the insured or a claims preparation service in preparing the claim that includes the insured's inventory. For example, in one embodiment, a 360° video of each room in the insured's office or dwelling is provided, and each of those videos may be examined in detail to help construct an inventory of items. In addition to the panoramic videos, special or high value items may be photographed separately. In many cases, the images permit a unique identification of the item, such as a discernable serial number and product part or model number. In addition, the images can show the amount of wear and tear on specific possessions.

In other embodiments, tools are provided to provide a convenient link between the inventory and an appraised tool such as Insurers World™.

### SUMMARY

eProoft Digital Inventory Service™

One embodiment of the current invention is a method and system for acquiring, selecting, organizing, and certifying a plurality of digital images in order to provide tamper-evident digital image documentation of residential and business assets. The documentation can be used for a variety of purposes including proof that the item exists, proof of the value of the item, e.g. jewelers' appraised value, fine arts appraisal, etc.

One service, eProoft Digital Inventory Service™ (DIS), provided by the applicant certifies and records digital testimonies through pictures, videos, voice recorder or digital documents of a customer's assets and inventories. This digital record of assets provides a testimony of ownership. The images are taken or collected, and then processed by a photographer or Preclaim Specialist™. The documents produced by the service incorporate several precautionary actions taken in order to clarify the authenticity of the Preclaim Specialist's™ work.

Clients and Insurance Companies benefit from the current invention by having an organized current inventory of belongings with the most advanced methods of filing and recording. One benefit to the client is the knowledge that the client's assets have been thoroughly documented in a certified manner, so that if a loss occurs, the digital inventory will provide support for a thorough claim for the loss.

Benefits to the Customer

The Digital Inventory Service provides several advantages to the customer. The service records up-to-date assets and inventories for the customer. In some embodiments, an update service is provided for items acquired after the inventory is conducted. The digital documentations recorded by the service provide advantages for several different objectives such as supporting insurance claims, loans or self-knowledge.

One benefit of the current invention to the customer is the organization of both images and related materials. Images may be organized in any desirable manner, typically by location such as the contents of a room; or by type, such as by gun, orjewelry collections. For instance, in one example, the digital inventory includes panoramic video of the contents of a room. Close-up images of some of the contents may be provided and conveniently accessed from the room images in order to view items in greater detail.

In one example, the images are delivered with an easy to use front end for accessing inventory entries. A variety of delivery platforms may be used including a DVD with a database user interface.

Related materials such as back-up documentation including receipts, appraisals, and third party testimonies may be stored with the image, or may be linked or referenced from the images or an index of terms.

In various embodiments, the current invention provides a tamper-evident digital watermark on the images, encrypts information related to the images, scrambles content, provides digital certificates, and provides key codes in image metadata. The digital watermarks may include visible and invisible marks that are present in both analog and digital processing of the images.

In the example of digital watermarking, watermarking provides authentication and copy protection for use with digital and analog certification of an image. It can be performed on images, documents, audio, and video files, and it opens a complete range of solutions for protecting the management and distribution of confidential digital content. It also will strengthen the security of the license issuance process. Sophisticated document authentication, reducing the possibility of fraud. Imperceptibly embed digital information in both digital media content, including digital images, video, voice recordings, and documents; and in conventional printed media content. Can be used as a persistent asset inventory tag, acting as keys into a digital asset management system. Any piece of tagged content can be followed back to the original store, or stock of consumer's goods, in an asset management system. Tagged content can also link metadata such as key words, descriptions, marks, rights and permissions, certification of authenticity, etc. into the digital asset management system.

In one example of certification through encryptions, eProoft implements the AES encryption algorithm (128 or 256 bit, etc.) for sequential and sub-sequential identifying Product Key Infrastructure PKI, which issues the digital signatures and a certificate of authority. The US Government has announced that the AES standard is secure enough to protect all levels of classified information, including top-secret government files. This ensures that content is unalterable and un-viewable by any third party, allowing eProoft Inc. to maintain the privacy and certification of the content.

In one example of content scrambling schemes (CSS), an industry standard encryption scheme is used for production level DVD discs. This encryption may be in addition to watermarking or other security features on the images. The encryption prevents unauthorized editing or manipulation of data stored on DVD disc. Content Scrambling also is used on the internet by scrambling the content into more than one server. Permissible rights will be granted to eProoft for use of the server(s) in which the content will be sent to.

In one example, digital certificates are used for certification of images through a third party trusted digital authority is given to the parties that hold the digital certificates

In one example, key codes in image metadata aid in the identification to the event, document or the item that is captured for digital documentation.

In one example, the digital data may be uniquely identifiable not only by the digital image, but also by the story or historic preservation of one's testimony of ownership or background. This verbal or video annotation may provide a valuable providence in the case of collectible items, or simply provide sentimental value to family heirlooms. This additional description may aid in the retrieval of stolen or lost assets. Law enforcement agencies and regulatory bodies have their state of the art methods of searching for items missing or evidence aiding in these items recovery. They have plug-ins that link them to certain search engines and databanks/databases, such as pawnshops or online auctions for data relating to the specific item being; such as serial number, id numbers or codes, or marks. The metadata can be a useful item for many identification objectives.

In another certification example, the lens used by eProoft's cameras is manufactured to our own specifications. For instance, the lens is laser etched to provide a tamper-resistant environment in which the image will be marked physically and therefore made digitally challenging to alter through all the security layers provided by eProoft. The lens may also have a uniqueness to them; like having a curved, convex or inverted lens set to a certain predetermined angle that can make the picture easy to be identified as one of eProoft's images giving them authenticity.

The certification processes provide assurance to an insurance company that images were created at an earlier date, and that the images have not been modified. This certification is useful for both the insurance company which can avoid fraudulent claims, and for the customer who can have the confidence that the inventory is well-documented.

The certification may also be useful to other interested parties such as mailing services, product delivery service industry, moving companies or data escrow and escrow Services

The images and related information are readily available for personal or professional purposes. The image remains certified throughout analog or digital use or conversion. In one embodiment, eProoft is notified of use, distribution, or publication of still imagery on the internet via Digimarc™ SpiderMark™ image tracking system. The inventory record is monitored and kept secure.

The DIS provides an aid in providing protection if there ever is a dispute of ownership or value.

The customer has an increased awareness of assets and the need for a proper determination of adequate insurance coverage. The inventory can be used to evaluate insurance coverage and protection of possessions. The inventory process can also stimulate need for appraisal of certain valuables, which eProoft can provide through licensed and credible contract services.

In one example, the customer is protected by having a photographer that is insured and bonded. In another example, the service technicians are trained in assisting the customer process insurance applications or claims. The DIS can provide the customer with an ease of mind about dealing or arguing with insurance adjusters in the event of a claim.

In one example, the current invention provides a consolidation of an entire inventory of assets into one simple viewable and searchable file or DVD.

Benefits to the Insurer

From an insurer's perspective, the service provides reassurance for a customer's insurance. In the absence of a prior inventory, an insurance claim is typically prepared based on the customer's recollection of what the customer owned at the time of a loss. One aspect of the present invention is to provide a method for obtaining a set of images which provide a complete list of items, proof that the customer owned or claimed to own the items at the time of the inventory, identifying marks such as serial numbers or other distinguishing features for at least some of the items, and a basis for valuation of the items based on the visual appearance of the items at the time of the inventory. The methods support a prompt and complete processing of a loss claim.

The Digital Inventory Service (DIS) process is based on a detailed knowledge of how insurance providers deal with their clients, before and after a claim for a loss such as theft, fire, or flood. The service is also based on the recognition that the clients need to have a full accounting of their assets before a loss.

In one embodiment, the invention stores inventories and testimonies in a secure confidential data base. The customer's possession inventory may be proven through this record.

Another aspect of the invention is a second party certification. The second party certified record that eProoft, Inc. provides is a confidential, certified, authentic record, and tamper resistant record. An unaltered record provides an independent certification of the inventory.

The certification process, and the verification that images were collected at a date prior to a loss claim, helps to reduce or eliminate fraudulent claims. In one embodiment, the sequential pattern of images provides a method of asset coding and reference without relying on physical asset description. The consumer can make changes of inventory without changing the order of the current inventory's sequential patterned documentation by adding events or items to the end of the existing patterned sequence. Another example, the customer can make keep up-to-date additions through a re-inventory process that renames all images again in batch format with Image Serializer. The new images are added in with the old images a way to keep the sequential pattern of digital documentation of assets and inventories. This merger may be facilitated by metadata references.

In one embodiment, the logical arrangement of images in a data file or CD provides an efficient basis for preparing and reviewing an insurance application.

The arrangement of images also helps to prepare and substantiate insurance claims.

The availability of certified images improves consumer confidence that the insurance company can and will protect assets. This approach to documenting assets, verifying extent of coverage based on actual assets, and preparing and proving claims based on actual assets can help to improve an insurance company's image and public relations.

By offering policy limits and endorsements based on the actual assets, an insurance company may increase insurance coverage and premiums.

Certified Event Acquisition Device

Another example of certifying digital images is when certification is done within the hardware used to gather the inventories. In one example, a Certified Event Device CED and may be a combination of camera and other devices including a display, keyboard, global positioning system (GPS), timer, or other devices. Images or other data acquired with the device can be certified with digital markers that include date and location or other information. Each image may record, as metadata or as a watermark, a time, location, hardware identifier, etc. In some examples, the device prompts for more information that may be typed or scanned. A menu may be provided with a complete index of options that can be performed. The data is certifiable because the devices captures where and when the image was shot along with any entries made by the Preclaims Specialist™. This information permits a determination of the GPS location of where and when the image was taken. The method is also useful for certifying images that the consumer wants to inventory or add to their existing inventory. In one example, the unit includes software that functions to automatically detect an estimation of the square footage of the room being photographed. In another example, the device determines the vicinity of a specific open or closed location in which the device captured the event or item. The CED may use encryption rather than a watermark as its primary certification means. The system software may be made inaccessible to the user.

Escrow of Images for Subsequent Editing or Updating of the Inventory

Another embodiment of the current invention is a method for escrowing the certified images in a manner that facilitates updating an inventory file.

Remote Acquisition of Images Certification

Another embodiment of the current invention is a system and method for remotely acquiring images, and organizing and certifying those images as an inventory of items for a business or household.

In one embodiment, the images are captured with special hardware as described above.

In other embodiments, images are acquired with conventional digital still or video cameras. The captured images are then communicated via a computer network to a service, such as eProoft, that provides a certification to the set of images.

### BRIEF DESCRIPTION OF THE DRAWINGS

FIG. 1A is an example of a prior art claims form.

FIG. 1B is an example of a partially filled-out claims form of FIG. 1A.

FIG. 2 is a flowchart for onsite image acquisition and subsequent processing.

FIG. 3 is a flow chart showing a representative set of detailed tasks completed on-site by a DIS provider.

FIG. 4 is a flow chart showing a representative set of detailed tasks completed off-site by a DIS provider.

FIG. 5 shows an example flowchart for the serialization of a set of images.

FIG. 6 is a flowchart illustrating the use of Digimarc watermarking software.

FIG. 7 is a flowchart showing the potential use of DIS in verifying assets before and after a client moves residences.

FIG. 8 is is a flowchart illustrating the basic DIS procedure from start to finish, from initial contact through the production of the finalized inventory DVD

FIG. 9 illustrates the use of a secure destruction process of digital media and the creation of a certificate of destruction.

FIG. 10. illustrates the packaging of the finalized DVD with the certificate of destruction for delivery via courier to the client.

FIG. 11 illustrates the packaging of the finalized DVD with the certificate of destruction for storage at a licensed offsite secured storage facility.

FIG. 12 illustrates the digital packaging of the finalized DVD with the certificate of destruction for entry into an secure internet accessible relational database.

FIG. 13 illustrates the procedure and format of a client accessing a secure relational database in order to view a DIS item record.

FIG. 14 illustrates the procedure of obtaining and using a Certified Event Device for creation of a DIS.

FIG. 15 illustrates a system to acquire a CED from eProoft.

FIG. 16 illustrates the Certified Event Device system itself

FIG. 17 illustrates the possible systems of transferred certified data from the CED to eProoft for processing and production.

FIG. 18 is a system diagram illustrating various examples of the use of a kit.

FIG. 19 is an example of a visible watermark.

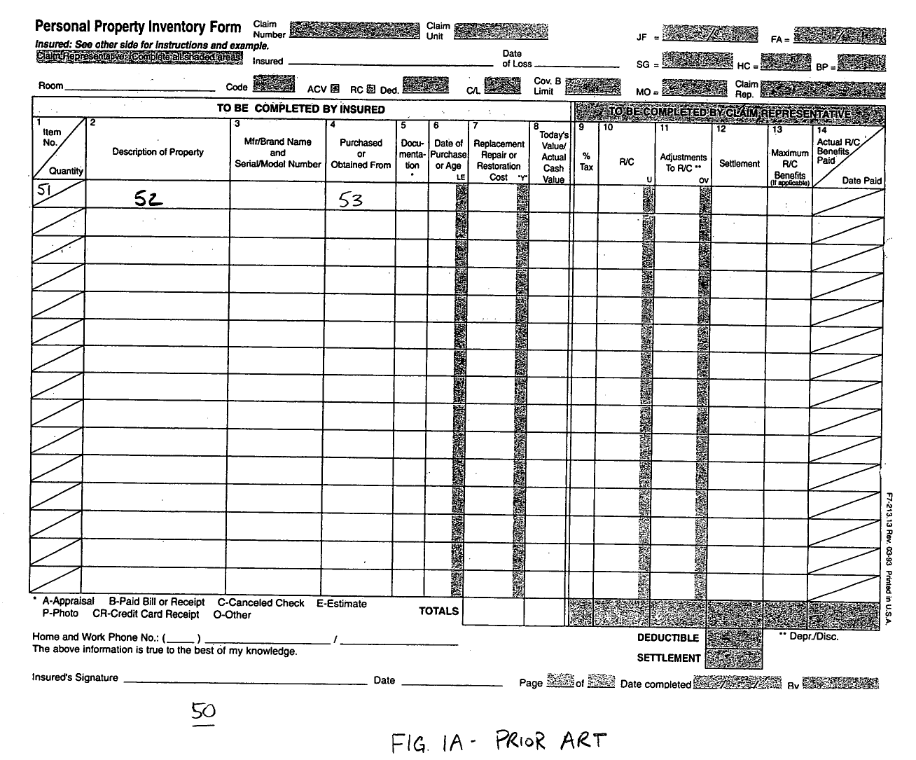

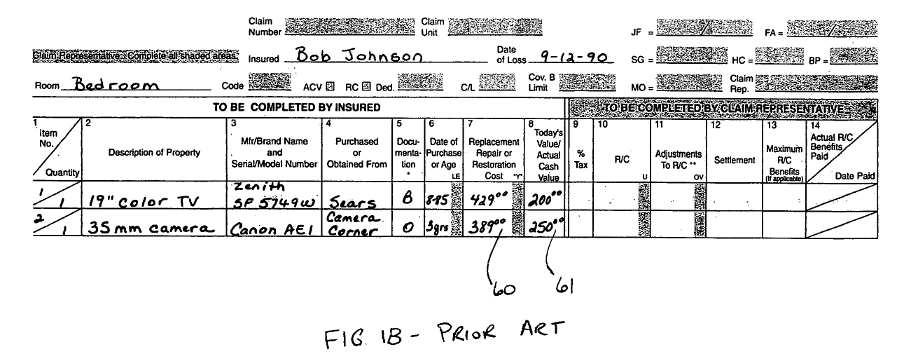

### DETAILED DESCRIPTION OF EMBODIMENT

### On-Site Collection of Images, Processing and Certifying the Images, and Preparing Media

In this embodiment, images are collected at a customer site. Typically, the images are collected by trained technicians. The collected set of images is then processed to produce a set of processed images that is provided to a customer in DVD or other format.

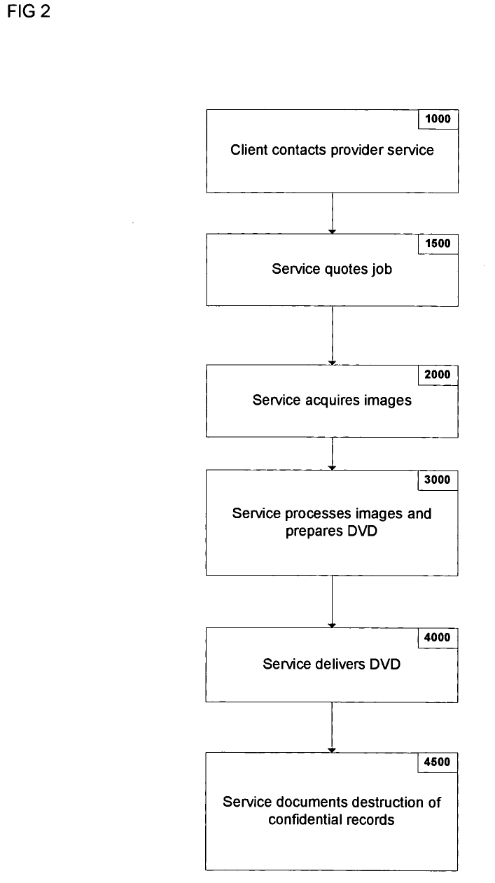

FIG. 2 shows a flow chart for providing image acquisition, image organization, and certification services. At step 1000, a client 102 contacts the provider service 105, such as eprooft. Typically this contact would be by telephone or email. eprooft, Inc. is a provider of the digital inventory services, and the terms provider and eProoft are used interchangeably in this specification.

At step 1500, the provider service quotes the client's job. The quote may be prepared with guidelines such as the size of the house or business facility, the number and types of rooms, and the types of special collections.

At step 2000, the provider acquires images. The service provider technician may be a Preclaims Specialist™ as described below.

At step 3000, the provider processes images and prepares a DVD or other format.

At step 4000, the provider delivers the DVD. Typically, the DVD will be hand-delivered or mailed. In other embodiments, the images may be sent electronically to the customer.

At step 4500, the provider provides a certificate of destruction for the client's images and records. In other embodiments, the materials may be maintained by the provider or an escrow agent, so that the materials may be used to update an inventory at a future date.

### EXAMPLE

### On Site Procedure

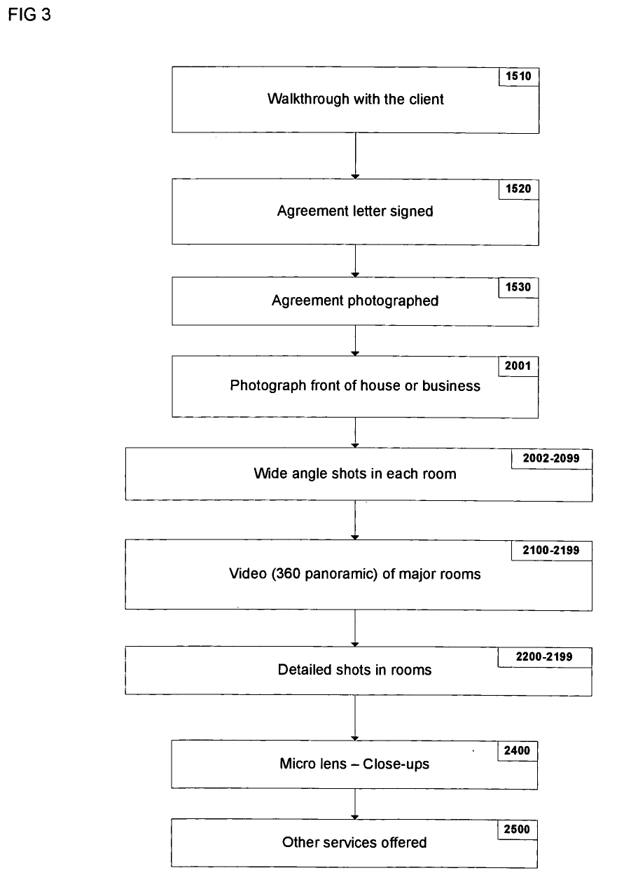

FIG. 3 is a flow chart showing a representative set of detailed tasks completed on-site by a DIS provider. At step 1510, the technician makes a walk-through inspection with the customer to determinejob scope. At step 1520, a letter agreement or contract is signed.

At step 1530, the agreement is photographed to become part of the inventory service records.

At step 2001, a photograph is taken of the front of the house or business. At steps 2002-2099, wide angle shots are taken in each room. Typically, these shots are taken while standing in two corners of each room, and this is done in a room by room fashion. At steps 2100-2199, a 3600 panoramic video of major rooms is done from a tripod placed at the closest point to the center of the room. At steps 2200-2299, a set of quick photographs are taken without a tripod room by room with more detailed shots such as paintings, clocks, and room decor. It is desirable to take enough photos that everything is visible at some view and detail is noticeable to things that the specialists or the consumer holds value enough to stand alone. At step 2400, close-ups and more detailed shots such as serial numbers, markings or any sort of uniqueness are taken. Typically, these shots are made with a close-up lens. At step 2500, other services may be offered such as for the disposition of property in a will, support for a prenuptial agreement, and support for real property documents such as a deed, lease, or mortgage. Other services may also in depth documentation of records, or pictures that consumer already has but would like to have certified and digitally documented. Other services may also include an in-home fire proof safe installation.

Other service options include bar coding, or otherwise tagging, assets and inventory; preparing a detailed Inventory List according to categories, preparing an accurate asset verification-database; documenting assets before and after a move; video or audio recording of asset history. The service may also comprise referring the customer to a web site or entity for appraising the inventory items, such as thorough an on-line auction service. Another third party service is an escrow service that retains a copy of the DVD or of the electronic files. A catalog of assets may also be generated. Future services may include provided an after-disaster appraisals conducted with photographic content of particular assets to provide an estimation of depreciation cost to the consumer and insurer.

In the case of collectables, or other special items, the customer may provide a providence to specific items such as history, time, stories and other essential evidence needed to prove more value on certain items. An example of this service would be a 1858 Model Winchester Military Issue Revolver in good condition like at a 97% rating is worth about $3000. However, if this gun had a documented providence, such as a proof of purchase or story of the guns past, then the gun will be significantly more valuable.

### EXAMPLE

### Off Site Procedure Processing

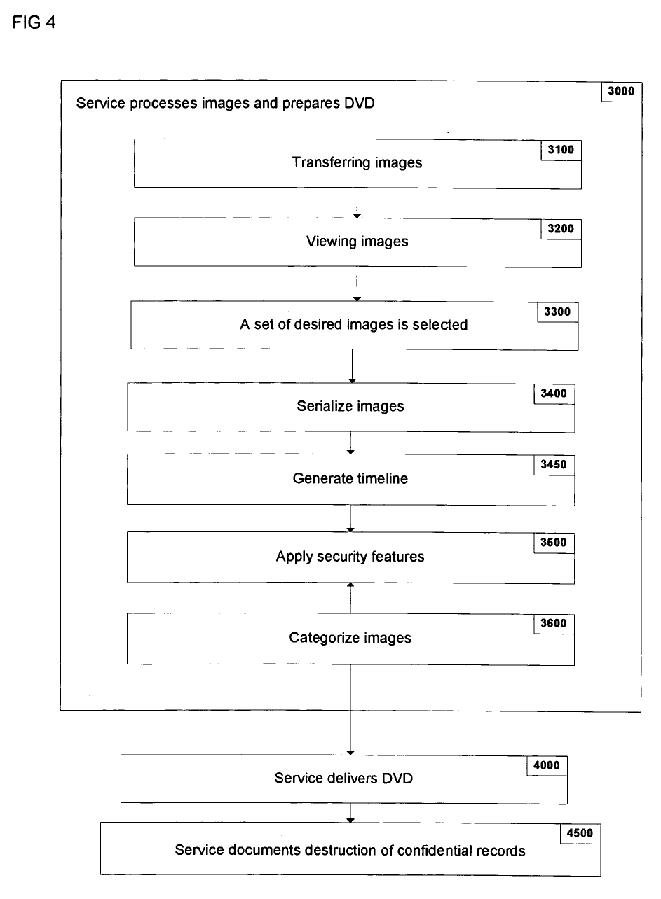

FIG. 4 is a flow chart showing a representative set of detailed tasks completed off-site by a DIS provider. At step 3000, the service processes images and prepares DVD. In this example, the processing comprises transferring digital images 109 including video footage to a service computer at step 3100. As a temporary backup, all images maybe backed up to a CDR disk, and of all images/videos captured and destroying this disk after a DVD is successfully prepared. At step 3200, the images are viewed, and duplicates or non-readable images are stored in a new folder named “extra”. At step 3300, the pictures are organized in thumbnail view according to the desired linear play ordering. At step 3400, all selected images are renamed. At step 3500, security features are applied. At step 3600, the images are categorized to produce set of processed images. At step 4000, the service delivers a DVD to the customer. At step 4500, the service documents its destruction of confidential records.

Initial Contact with Customer

In one embodiment, the customer contacts eProoft, such as by customer call or email, In another embodiment, eProoft will contact the potential customer such as by email or telephone call, based on a referral or cold call. In another example, a webpage provides information and provides a method for a customer to contact the service. In one example, an insurance company recommends the service provider to its policyholders.

It is desirable to prepare a customer before the time of acquiring the images. In one example, a brochure, letter, or email is provided to the customer. The document suggests that the customer think about what items to document so that the items are accessible at the time of inventory. Many items are normally unseen and things that need special attention is given then place them on the bed, table, or floor. The customer may also be asked to consider which items are special, and might warrant a testimony of ownership or family history. The document would ask for notice of any items that need special attention, especially for estimates or appraisals.

In one embodiment, the customer contracts with the inventory service, and determines which service package is needed. These contracts may include provisions for subsequent updating of an inventory. The contract materials may include a signed invoice stating the consumer has received the service. The contract typically describes options on services plans and product line.

In one embodiment, ancillary documents such as customer contracts with the inventory service, other agreements, and certified documentation is collected on a DVD and a database.

The certified documentation may include one or more affidavit stating that all of the pictures or videos taken are of items, which the consumer or business owner currently owns.

The service may include a choice of related purchased or complimentary products including a Pad folio designed for retention in a safety deposit box or other safe place; a fire proof safe; logo merchandise for the service provider; special inventory pads, memo pads, pens; and scrap booking materials including photo prints and bound photo albums.

Another service option is to prepare extra DVDs such as for other family members and/or off-site storage.

Another service option is to provide a slide show or virtual-tour of a home. The slide show or tour may be provided in copy-protected media with tamper evident and fully certified digital image documentation. In one example, this type of information can be used to support the condition of a home at a given time, such as during an inspection of a home.

Another service option is to allow the client to appraise the inventory themselves and to have the self-appraisal included with the digital documentation. The self-appraisal may be added at the time of image collection, or at the time of DVD preparation and assembly. The appraisal may be in the form of a written document which is scanned, or may be a video of a customer explaining the significance or value of an item.

Documents related to inventory items, such as receipts, may be scanned or photographed. These related documents may be processed in a manner similar to the images with watermarks or other security features.

Another service option is to incorporate oral or video descriptions from a client about the family significance of particular items. This type of description preserves information that is often lost between generations. The description may include the origin of an item of furniture, an explanation of who is shown in various old photographs, or a favorite hunting story from an old gun.

Another service option is for the provider, or a third party, to maintain the inventory information so that changes and additions can be made at a later date. The add-on service may be provided with interactive technical assistance, such as instructing the customer what to photograph, or how to photograph an item; and how to submit a set of subsequent images to the service.

In one embodiment, electronic files or records are destroyed after an inventory is prepared, and a certificate of destruction is provided to the customer.

In this example, the customer may select a background music preference and a template eProoft themes are professionally designed audio and visual themes that provide a variety of choices to tailor to the customer preferences. The DVD may have fully functioning interactive capabilities with electronic media.

The service provider may provide a follow-up service in event of a loss such as a natural disaster, a theft, or a fire. The follow-up service may include assisting the customer in preparing an insurance claim for the loss, or obtaining an appraisal for the lost items.

The service provider may distribute guides, pamphlets, news, articles, and briefs on creative ways of conducting inventory updates. These types of materials promote the marketing of the service for both follow-up work and for referrals.

Pricing is typically based on an estimated number of items, or estimated room sizes, with additional charges for special collections. In one example, the pricing is based on reviewing an online subject questionnaire that a consumer provides after taking time to think about the questions and objectives. In some examples, a service is provided with monthly, quarterly, or yearly update service.

Examples of inventory item categories for a home are jewelry and furs; firearms; goldware and silverware; business property including tools and merchandise; personal tools; collections; televisions, stereo, tapes, and records; fine arts, antiques, and rugs; musical instruments, cameras, and sports equipment; and computers and software.

Image Acquisition

Referring to FIG. 2, at step 2000, the provider acquires images of the customer's inventory. In one embodiment, a Preclaims Specialist™ service provider technician acquires the images at the customer's home or business.

The provider typically sends a preliminary set of instructions and suggestions to the customer, so that the customer can prepare for the on-site inventory. These suggestions include a listing of special items and collections; a request to gather small collectibles and valuables to make their cataloguing easier; and a request to collect any pertinent paperwork that accompanies collectibles, such as certificates of authenticity, for digitization. Items that require special care or attention should be collected and placed in a neutral area for photography, such as a bed or table. These items include safe contents, jewelry, fragile collectibles, or any other item the client desires to have control over during the DIS process. Client does not need to provide fragile items such as china in a cabinet if it is in plain view suitable for photography. A typical photographic session takes about 2 hours. Special collections or extra rooms will typically take longer.

In one example, the service prepares a secure DVD record from the photographs and videos. One or more DVD and a certificate of destruction of the data are delivered to the customer. The customer is advised to store at least one DVD away from their home, such as in a safety deposit box.

The customer may be advised that there are several options on how to handle property acquired after the inventory. One method is to make a written record in a logbook, which is provided by the service. Another method is to make a supplemental DVD. Another option is to replace the DVD as described in an embodiment below.

A website is typically provided for technical support, training manuals, tutorials, and related software for download. An example of downloadable software, is a software that allows the CED, adaptor, remote access, or plug-in device to be read by the consumers computer linking them to eProoft's headquarters. Another example of certification is a ranging device issued to the consumer with the purchase of eProoft Inc.'s service, which can be used to detect the location, or range of the location in which the device was used. The website may also include information about data acquisition; insurance and insurer's regulations and policies; news, stories and statistics showing the importance of certifiable digital documentation; and appraisal services.

The image acquisition preferably follows a general sequence of images beginning at the entry to a home or business. The image acquisition typically includes panoramic videos of each room. Additional images of items in a room are taken as necessary. Close-up images are acquired for serial number or other details.

Image Processing and DVD Preparation

At step 3000, the provider processes images in order to support the preparation of a DVD or other format. FIG. 4 describes the image processing in more detail. At step 3300, a set of desired images are selected. At step 3400, the images in the timeline are serialized. At step 3450, the serialized images are arranged in a timeline. At step 3500, one or more security features are applied to the serialized images. In other embodiments, the serialization is performed after the timeline is generated. The image processing can be done a Macintosh or PC platforms.

Step 3300—Selection of Desired Images

In one example pictures are organized in a Thumbnail view images are selected from this thumbnail view in a desired sequence, such as room by room, or wall by wall within a room. The images are selected, and cut and pasted into a desired location within the timeline. Once the images are deleted, the image serializer is used as described below.

Step 3400—Image Serialization

In this embodiment, an image serializer is used to facilitate the preparation of an organized set of images.

In one embodiment, image files are entered into an image serializer in a desired final order. In this example, there is no reordering of the files once they are loaded into the program. In this example, the ordering must be performed in a tool such as Windows Explorer™ before the images are dragged into the image serializer window. This is a problem because Windows Explorer does not retain arbitrary ordering of files. If the window is accidentally closed, or the view is changed during the process, all of the ordering performed up to that point will be discarded and will have to be restarted from the beginning.

In another embodiment, the image serializer software provides a capability to sequence and re-sequence the images. This capability allows all of the desired images to be dropped into the image serializer, and then organized via an up/down arrow or drag and drop interface within the program itself. The images may be represented by thumbnail images so that multiple images may be viewed and manipulated within a single screen display of the image serializer. This process greatly simplifies the organization of a large number of images, while at the same time reducing the possibility of an error which would require the user to restart the organization task.

### EXAMPLE

### Image Serialization

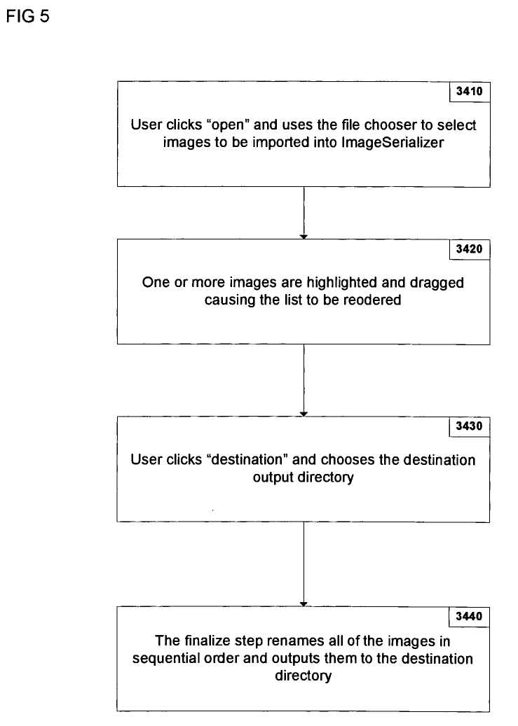

FIG. 5 shows an example flowchart for the serialization of a set of images. In this example, double clicking on image name deletes the image At step 3410, the open icon is pressed and a file chooser appears. The desired images are selected using the file chooser and are loaded into the Image Serializer window. As the images are loaded, they can be viewed, such as by thumbnails, in an Image Serializer software window so that an operator can verify that the images are in the correct order. The images can be re-ordered as necessary. At step 3420, a destination output direction is selected. At step 3430, the serialization is finalized by selecting a finalize icon. At step 3440 the finalize step renames all of the images in sequential order for identification, additional value, and preparation of the DVD or appropriate media. Typically the images are assigned numbers such as 00000, 00001, etc.

The serialization process typical uses temporary folders. In one embodiment, the set of images are retrieved from an Image Serializer folder, and moved into a working folder. The old images and the images in the “extras” folder are moved into a folder named “original”, and this folder will typically be destroyed after the processed set of images is successfully produced. A main folder is provided for a customer, and separate folders are typically created for video, images, an image subfolder extra, timelines, and a timeline subfolder DVD timelines. A standard folder naming convention is used to avoid ambiguity and confusion. Files are maintained in their appropriate folders.

Step 3450—Timeline Generation

In one example, the images, video, and other data are arranged in a timeline in a DVD format. The timeline arranges the display order for the images. For instance, each still image may be displayed for a few seconds before the next image is shown. In one display mode, a DVD will repeatedly display a set sequence of video and still images. In another display mode, the images are categorized and indexed so that a viewer can go directly to a desired room to view its contents. In one example, pictures are organized in List View for a better look at the files just by their name not image.

In a typical timeline, the images and videos are arranged as a virtual tour of a home or business, starting at the main entrance and introducing each new room with a panoramic view. The timeline is built by inserting the panoramic video at one point in the working timeline, and then showing a sequence of still images, such as each wall. Detailed images may be inserted as desired into this sequence of images. Special collections may be inserted into a room display or in a separate section of the timeline.

Step 3600—Categorizing Images

Categorizing provides a useful index to the set of images. In one example, a searchable database is presented as a simple spreadsheet. This example provides a means of easy searching and a scalability capacity. There are various methods of presenting the index, such as by rooms, by collections, or by related terms.

In one example, a Numbering Items Software provides a universal, non-repeating item identification code so that an image is uniquely identified.

Color Correction

Color correction may be accomplished with a tool such as Adobe Photoshop. In one example, each image is automatically adjusted to color correct and to a NTSC or PAL color standard.

Project Image Timelines

In another example of project image timelines, there is a method of presenting the index of images to the consumer in an organized sequence. In one example, the timeline can be broken up into multiple parts and viewed accordingly. In another example, the timeline can be one continuous timeline that is viewed such as a “play all” feature on the DVD.

In one example, a common pre-installed non linear editing program which is provided with most computers, or which are free downloadable, are used to change the file format of an image and video file. The software permits the video or still images to be put into DVD format (NTSC or PAL).

In another example of creating image timelines, software that provides more options is used. An example of this software is Adobe Premier Pro or Final Cut Pro.

Step 3500 Adding Security Features

The method of adding security features can be done before or after Step 3600.

Certification

One or more forms of a certification may be provided for an inventory item. Some examples of certification include a certification of images, affidavits or statements from an owner of the item, receipts, formal appraisals, owner appraisal estimates, item history the story or provenance of item, and serial numbers or other individual item identification. These forms of certification may be referenced or logged within metadata associated with the images.

In one example, Adobe™ software gives customer the ability to view their assets on a read-only digital media that contains all of the same secrecy methods. The media may provide a virtual tour of a customer estate. Each media may be individually catered to customer's desired product.

Adobe and other software uses file information called metadata, which is important in publishing and other applications. The metadata identifies transmitted text and images including entries made for descriptions, keywords, categories, credits, and origins. Metadata may be attached to the digital image of the item in the database in a tamper evident fashion. The image may be certified with watermarks and verification that the image was taken by eProoft Inc., with eProoft Inc. identification and the year and date taken. A portion of the metadata is categorized and communicated to the spreadsheet database that presents it by searchable types such as camera ID and date. Some of the metadata may be used in generating a watermark.

Regardless the platform, Adobe software detects any added file information to the original file. The information that is added is embedded in the file using eXtensible Metadata Platform (XMP). XMP supports application XML framework which standardizes the creation, processing, and interchange of metadata across publishing workflows.

In one example, the Adobe software adds digital copyright information.

Digital Watermark

In one example, a Digital watermark is added to notify users that the media is copy-protected. The Digital Watermark may use Digimarc™ ImageBridge™ technology.

The watermark is a digital code added as noise to the image, and is virtually imperceptible to the human-eye. The Digimarc watermark is durable in both digital and printed forms, surviving typical image edits and file format conversions.

### EXAMPLE

### Digimarc™ Watermarking Software

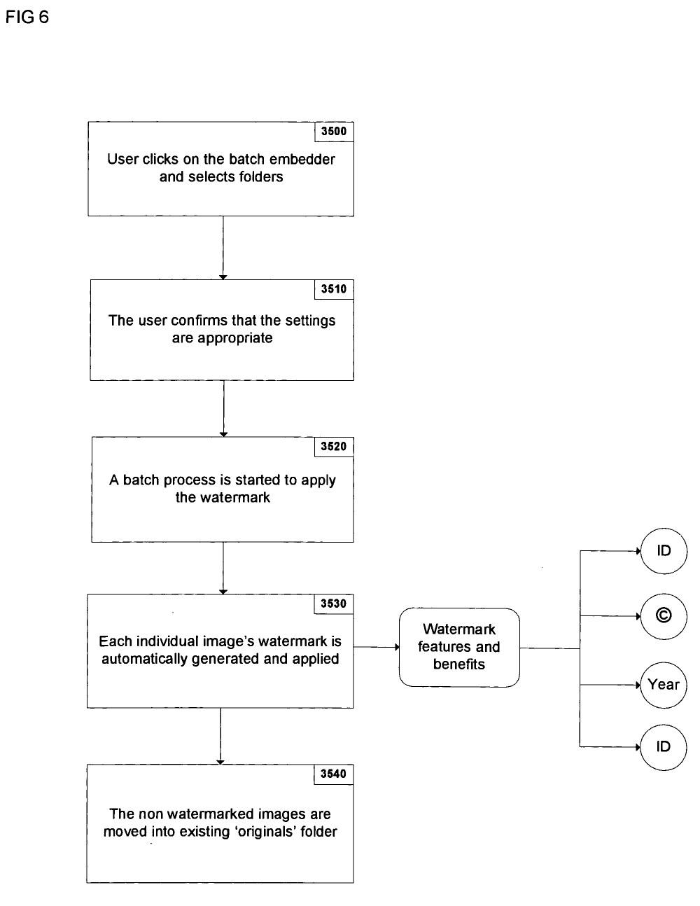

FIG. 6 is a flowchart illustrating the use of Digimarc watermarking software. At step 3500, the user clicks on the batch embedder and then choose the folder that all of the images are in, and chooses a destination folder for the images. At step, the user confirms 30 that settings are appropriate for the watermark. In this example, the watermark includes eProoft Inc.'s ID code, a “Restricted use, do not copy” notice, a Copyright year, a visible watermark, and an invisible watermark keyed into the metadata. If image is opened in certain software, a copyright symbol appears right before the name of the file. Visible watermark can also be uniquely identified by RGB alpha settings. In this example, eProoft's visible watermark is positioned at the bottom right hand corner of an image, and that the durability is set best for a jpg format. At step, a batch process is started to apply the watermark. At step, the non-watermarked images are moved into existing ‘originals’ folder.

### EXAMPLE

### Digimarc WatermarkPro™ Watermarking Software

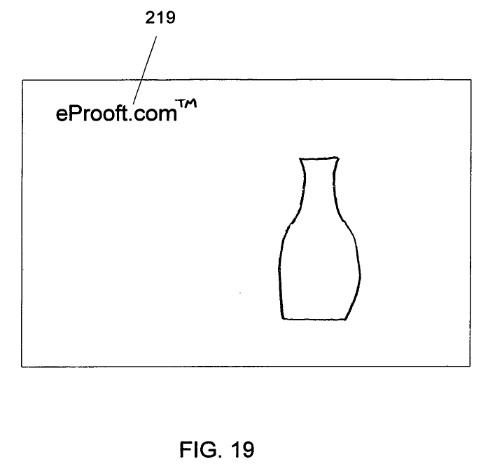

In this example, a watermark is visible on all digital media. An invisible watermark on all digital media becomes visible when the cursor or arrow moves in line with it. FIG. 19 is an enlarged view of a sample visible watermark.

Analog or Digital Tamper-Evident Images

In the example of digital watermarking, watermarking provides authentication and copy protection for use with digital and analog certification of an image. It can be performed on images, documents, audio, and video files, and it opens a complete range of solutions for protecting the management and distribution of confidential digital content. It also will strengthen the security of the license issuance process. Sophisticated document authentication, reducing the possibility of fraud. Imperceptibly embed digital information in both digital media content, including images and video; and in conventional printed media content. This example can be used as a persistent asset inventory tag, acting as keys into a digital asset management system. Any piece of tagged content can be followed back to the original store, or stock of consumer's goods, in an asset management system. Tagged content can also link metadata such as key words, rights and permissions, certification of authenticity, etc. into the digital asset management system.

In one example of certification through encryptions, eProoft implements the AES encryption algorithm (128 or 256 bit, etc.) for sequential and sub-sequential identifying Product Key Infrastructure PKI, which issues the digital signatures and certificate of authority. The U.S. Government has announced that the AES standard is secure enough to protect all levels of classified information, including top-secret government files. This ensures that content is unalterable and un-viewable by any third party, allowing eProoft Inc. to maintain the privacy and certification of the content.

In one example of content scrambling schemes (CSS), an industry standard encryption scheme is used for production level DVD discs. This encryption may be in addition to watermarking or other security features on the images. The encryption prevents unauthorized editing or manipulation of data stored on DVD disc. Content scrambling also is used on the internet by scrambling the content into more than one server. Permissible rights will be granted to eProoft for use of the server(s) in which the content will be sent to.

In one example, digital certificates are used for certification of images through a third party trusted digital authority is given to the parties that hold the digital certificates

In one example, key codes in image metadata aid in the identification to the event, document or the item that is captured for digital documentation.

Another security feature is a a cyclic redundancy check number. CRC check is a mathematical model that makes any alterations easily detectible

In one embodiment, Veri Sign™ provides digital certificates for all eProoft, software, copy-protected media and products. Digital Certificates enable the tracking of all the original settings and content in media that is certified including date, time and many other specifications.

In another example, the security of eProoft Inc. website will only let information be accessed through the I.P. address of registered consumer computers.

Another example of security is the site is protected in accordance to governmental or regulatory services' for on line security standards. The site uses Public Key Infrastructures PKI securing Internet transactions with digital signatures and digital certificates or like a secret key helps secure the database such as with an on line bank register. Certificates attest to a linkage or a specific type of association like an I.P. address or the consumer's computer identification and to the origin or ownership. The technique links the consumer, device, and item or event to a key pair through signature of a certificate authority CA. This example allows consumer to look at their inventory in front of their insurance agent or adjuster in the scenario of filing a claim application. The account can be accessed by an account password. In another example, the consumer can designate their I.P. address or computer identification as the only place that the files can be accessed. The online website of eProoft has options of downloading licensed and certified software. For example, multimedia interactively networked software can be used to educate the consumer. Assets can be accessed and reviewed through a secured website in a manner similar to reviewing a DVD at home.

In another example, Adobe-Encore DVD software is used to encode and render video to prepare it for the DVD. In this example, the transcode settings are set to automatically include copies of the certified images in a file format. In another example, the transcode settings are set where the consumer only viewed cannot access the files that are viewed on the DVD. In another example, the settings presented can limit the number copies allowed.

Location of File Storage

In one example, all data is kept digital on a SSL protected server that constantly mirrors that information in many different places. When it accessed by the consumer it appears on one server location and is only viewable by them.

There are many other types of potential security or certification techniques. Laser etching technology may be used to scribe a unique code on the camera lens or protective lens. This type of etching is very challenging to counterfeit. Another technique is to place a physical item placed in the scene before the photograph is shot such as a sign that says room 1, or a unique identification device.

Another technique is to change the color palette or color scheme. Changing the color scheme to a slightly different shade provides a legible image, while also providing away to confirm that eProoft provided the image. For instance, a practice of not using standard colors provides images that are unalterable and undetected.

In another example, solid metadata patterns are associated with each image. Each metadata is given key code identifiers that are unique to a consumer and eProoft.

Delivery of Service

In one example, eProoft takes digital footage, captures the client's inventory in a home or office, and then takes this footage for the preparation of the DVD. eProoft certifies the pictures and then makes the DVD. Upon completion of the DVD Package eProoft sends the product via mail or delivery service.

Another option is via web making the DVD a different service provided. Online secure database only that is accessible to the client for viewing and adding updates to.

The customer is typically advised to store the DVD or data files in a safe pale, and to provide a backup copy to be stored at a trusted off-site location. Some options for storage include an escrow service, a fireproof safe, safety deposit box, or family member.

DVD Delivery

At step 4000, the DVD is hand-delivered or mailed to the customer by the provider. In other embodiments, the images may be sent electronically to the customer.

In one embodiment, all documentation is given to the consumer with a release from eProoft, Inc. A copy of the documentation may be given to an insurance company upon request.

Another option is to store documentation in a third party escrow secure database, which cannot be released without the consumer's request. In one example, the database will be accessed through eprooft, Inc.™ code and the consumer's password. The escrow may be a physical DVD and document escrow, or a storage of electronic files. An example of an electronic escrow is the eProoft Digital Escrow Service.™

In one example, a standard DVD Package comprises two Inventory DVDs, and an Inventory Update Pad for keeping an up-to-date inventory. Other promotional materials may be included in the package.

Other Media Formats

A media format option is available to the customer to provide a choice of formats such as DVD or a compressed file that is available online.

Digital Inventory Service Spreadsheet

In one example, digital inventory service spreadsheet is provided to the customer. This spreadsheet provides a verification list with search capability, which may be used in preparing a claims form. This spreadsheet provides a categorization of customer's assets, and may be supplied in printed or file form. The file form may have links to item descriptions, such as at a vendor's website. The file form may also permit a search for the picture by clicking on the item name.

DVD Features

The DVD label may describe the contents of a DVD, which is one form of media that may be produced for an inventory. In one example, the DVD label indicates that the contents have been watermarked and scrambled.

In this example, security features include a Content Scrambling Scheme (CSS). This approach makes code reuse and design reuse is impossible except by the original author. The scheme requires a password to allow customer to view, but not edit, the images.

In one example, all copy-protected media software works on all digital documentations including on-line web. In this example, a software that is used for design and publication has a key, or license file to certify and protect the publication of the content and to provides certification. An example of this is a license such as a broadcast license.

Certificate of Destruction

In order to support customer privacy, the customer is typically offered the option of having the service provider certify that all confidential information has been erased or destroyed. In one example, the service provider supplies a certificate of destruction to the customer after the processed image set is delivered.

Preclaim Specialist™ Training

The Preclaim Specialists are provided extensive training in methods to preserve property ownership. This training may include identification of key assets and recommendations to the customer on obtaining appraisals on those valuables.

The training may include recommending regularly updated inventory; methods of identifying inventory items; methods of digitally capturing images of inventory and related documentation; methods to photograph or scan documents including actual receipts, appraisals, estate deeds, and ownership titles, video interviewing techniques with people that know the history and heritage of valuables, methods for creating a slide show or virtual-tour of the house, and deductive reasoning skills to determine customer preference.

Performance Measurement and Continual Improvement, DIS Time Log Analysis

In one embodiment of the current invention, data is collected for each inventory assignment so that the data can be used for continually improving the DIS process. The data also supports franchising efficiency by permitting a refinement of the data collection process, and by verifying that the inventories can be completed with the equipment and procedures recommended to franchisees.

The performance measurement may include a job cost estimate calculated from the DIS time log for factors such as the number of pictures taken on job, the square footage of house (could be approximate), and items in collections.

The data may be analyzed to answer questions such as which rooms are typically fast or slow to process, the best order of steps to follow to get the service completed in the bare minimum amount of time; the information necessary for a franchisee to conduct the data acquisition and prepare the inventory, and the efficiency or capacity of hardware and software tools.

### DETAILED DESCRIPTION OF EMBODIMENT

### Education and Certification of Preclaim Specialist™

The on-site DIS services are typically provided by a service provider's employees or contractors. The service provider may be corporate owner, or may be a franchisee. In one embodiment of the current invention, the service provider or franchisor offers extensive training for employees and contractors. The Preclaim Specialist™ trainees attend classes which cover insurance procedures and eprooft, Inc.™ procedures for Preclaims™, a direct sales technique, certification of official preclaims™, and other courses. The specialists are provided continuing education courses and current certification, so that the designation Preclaim Specialist™ refers to a currently certified technician.

The training is preferably modularized so that it may be offered through different insurance companies or adjustment agents in order to combine services for the consumer.

In some examples, the Preclaim Specialist™ may be a certified appraiser so that additional appraisal services may be provided.

The Preclaim Specialist may be a notary so that customer declarations or other documents may be properly notarized during the inventory process. In some embodiments, the client may be interviewed so that a written testimony can be prepared and notarized. For example, the client may sign an affidavit stating they own the belongings being videoed and photographed.

### DETAILED DESCRIPTION OF EMBODIMENT

### Validating an Insurance Claim

In this embodiment, the service provider offers a business service of preparing a loss claim for a customer. This service may include appraisal services based on the digital inventory; and personal assistance in preparing a claim.

In another embodiment, a kit or software is provided to the homeowner or small business owner to assist in the claims preparation. The software may allow the customer to select items for the claim based on an interactive image mapping. In some cases, the image of an item may be linked to an identification means such as a bar code or radio-frequency tag that was scanned at the time of the item image.

In the case of a theft loss, some or all of the inventory data may be supplied to the search engines such as the Justice Information Network for theft tracking such as the NLECTC virtual library.

### DETAILED DESCRIPTION OF EMBODIMENT

### Digital Inventory Service (DIS) with Online Database Environment (Internet Database) Access from Remote Source

In this embodiment, the data acquisition is conducted as described in the embodiment above, or the data is collected remotely. After processing, which includes certification of a set of images, the processed images with the security features are available online, such as through a secure website.

### DETAILED DESCRIPTION OF EMBODIMENT

### Digital Inventory Service™(DIS) with Online Database Environment (Internet Database) Access and Update

In this embodiment, a set of processed and certified images is maintained on an electronic database. A customer may update an inventory by requesting a supplemental DVD or electronic file of certified images; or may request a combination of the previous certified data with the supplemental images.

In the case of a request for a replacement DVD file, the customer will typically either return an original DVD to the service provider, request that an escrow service provide a stored DVD or file to the inventory service, or request that the inventory service use a DVD or stored file in its possession.

In the case of a supplemental file or DVD, the security features will typically include a new watermark and at least one other security feature.

In the case of a replacement DVD or file, the security features will typically include the original watermark on the original images, a new watermark on the supplemental images and other data, and other security features which preserve the integrity of the new combined file or DVD.

### DETAILED DESCRIPTION OF EMBODIMENT

### Secure Escrow Services for Images, Updating of Inventory

In this embodiment, an escrow service is provided to store a set of processed images. The inventory service provider may act as the escrow agent, or a third party service may be used.

The files are typically stored until the customer requests the image set. The requests for the image sets typically arises in either a loss claim situation, or when it is desirable to conduct an update of an inventory.

The escrow files may be stored in an anonymous fashion, such as by coded access to the files. In the case of a third party service, the escrow agent can provide another layer of security in certifying that data files or physical objects such as a DVD are the same as which were deposited in the escrow account.

The escrow service provides both a backup of media or files, and additional proof of authenticity. For example, in one embodiment, the customer may request that the escrow service forward a computer file or DVD directly to an insurance company to support a loss claim. In this example, the escrow service can provide an additional certification that the file or DVD is a copy of the material which was deposited with the escrow service on a given date.

### EXAMPLE

### Escrow Service as the Certification

In one extreme, the escrow service can be used as the only certification of a set of images, and watermarking and other security features need not be supplied. For example, a customer can forward a set of images directly to an escrow service, and have unaltered copies of that material sent directly to a claims adjuster in the event of a loss. In this example, the escrow service could typically only verify that it was forwarding either the original materials as deposited on a certain date, or a true copy of materials that had been deposited to the service on a certain date.

### EXAMPLE

### Third Party Escrow of Data Files or DVD

In this example, an escrow service is used for storing the customer inventory data in the form of one or more data files or DVD, and the subsequent updating of an inventory. The customer requests to use a provider escrow or a third party escrow. The service forwards one or more files, or the DVD, containing the processed images and related information to a third party escrow service or to the service's own escrow system. The customer can obtain the code and documentation from the escrow at a later time.

### DETAILED DESCRIPTION OF EMBODIMEN

### Digital Inventory Service™ (DIS) with Remote Acquisition of Images and Electronic Communication

In previous embodiments, the images were typically manually acquired; then physically transported to a processing location, such as an inventory services office; and then the set of images was processed at processing location.

In this embodiment, a set of images is acquired remotely, and the set of images are electronically communicated to a processing location. In other embodiments described below, the images may be acquired and transferred with the assistance of specialized hardware devices or storage media.

Remote Image Acquisition

Images may be acquired through many different types of devices including a customer's own camera or cameras, a device such as a cell phone that has an imaging capability, or custom image acquisition and certification devices such as eProoft's Certified Event Device.

After the image acquisition, in this embodiment, the images are communicated to a service provider for certification and other processes. In various examples, the communication may be accomplished from a customer's computer or from a remote service center, such as a kiosk.

Training Methods

The user may be instructed on image acquisition and data transfer techniques in a number of methods. Examples and tutorials including pictures, videos, diagrams, interactive multimedia, etc. may be accessed online, such as through a service provider's website. A printed or electronic training with in-depth instructions may be provided. An instructional CD or DVD may be provided for review at a customer's computer or television. A help line may be provided so that a customer may call to ask questions.

### DETAILED DESCRIPTION OF EMBODIMENT

### Remote Inventory (Access) Service (RIS)

In this embodiment, the inventory service provider provides a real-time coaching for guiding one or more customer through the inventory process. In one example, an inventory service technician can direct several customers simultaneously.

### EXAMPLE

### Real Time Coaching of Inventory Process

In one example, real time coaching of the inventory process is provided by a technician or Preclaims Specialist™ to the consumer presented in live virtual tour interaction, or demonstration of example from a control tower type setting such as air traffic control tower. In this example, the consumer is guided throughout the RIS using a technician or Preclaims Specialist™ in real time. This method may be useful in ways of presenting the customer a method of providing the RIS themselves.

In another example, the consumer performs RIS using a web camera provided by eProoft. This example provides consumer a unique web camera that identifies digital certification of input using watermarks.

### DETAILED DESCRIPTION OF EMBODIMENT

### Home or Business Inventory Kit

In this embodiment, a home or business is provided with an inventory kit 229 so that the customer may acquire images and conduct an inventory.

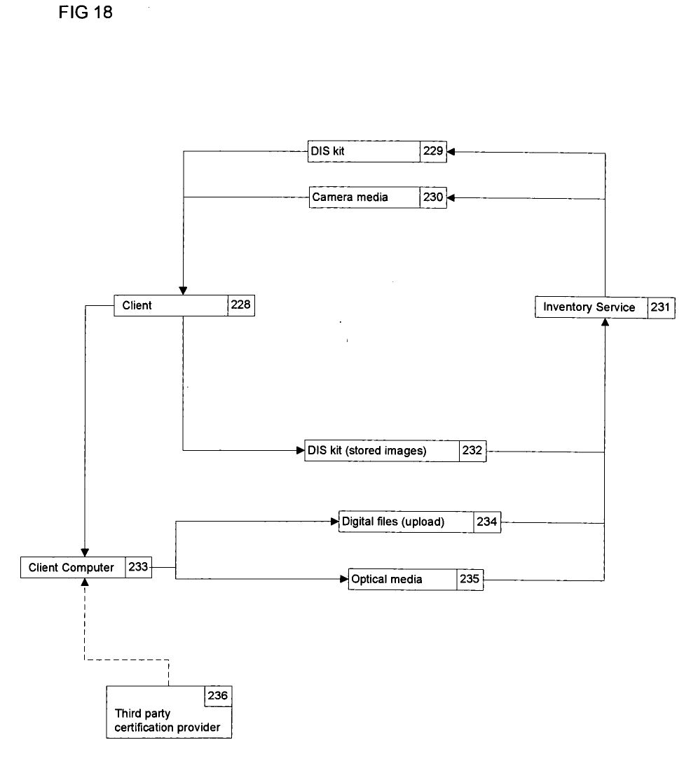

FIG. 18 is a system diagram illustrating various examples of the use of a kit.

### EXAMPLE

### Customer Sends Data to Inventory Service

In this example, a customer 228 obtains an inventory kit 229, obtains images and other information according to instructions provided in the kit or otherwise accessible. After the image acquisition, the customer sends data to the inventory service 231 by electronic data communication 234 or by sending a physical data media 235 such as a DVD.

### EXAMPLE

### Customer Sends Data to Watermarking Service

In this example, a customer obtains an inventory kit 229, obtains images and other information according to instructions provided in the kit or otherwise accessible. After the image acquisition, the customer certifies the data such as by using a one-time licensed watermarking software on the customer computer, or by sending the data directly to a certification provider 233, such as a watermarking service. In this example, customer privacy is maintained, and it is possible to process the images without human intervention.

### DETAILED DESCRIPTION OF EMBODIMENT

### Certified Event Device (CED)

In this embodiment, specialized hardware is provided by the inventory service. The hardware typically includes one or more features such as global positioning, internal clock functionality, a unique device id, voice recorder, or other sensors that can be used to associate metadata with an image. In some examples, this enriched metadata is used to generate watermarks and other security features that establish that an image was acquired at a specific place and time, or by a specific device or person.

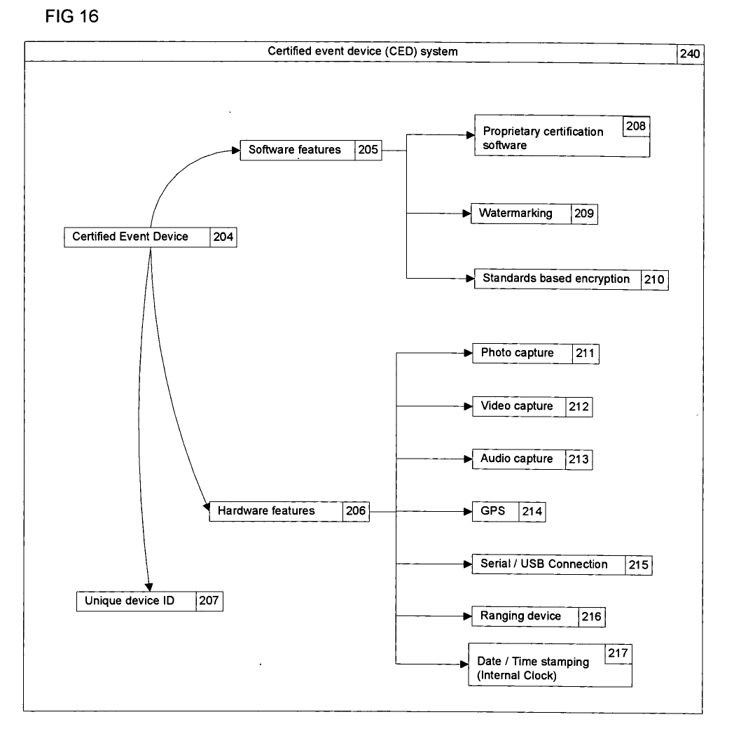

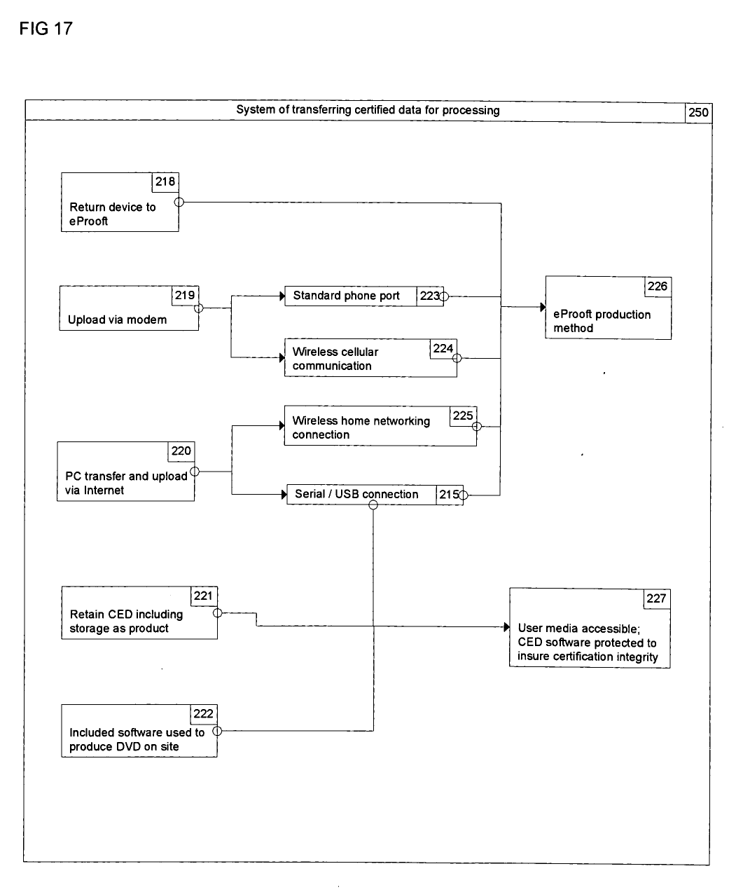

FIG. 16 is a diagram of a CED 204 showing a variety of hardware or data features including a unique device ID 207, proprietary certification software 208, watermarking 219, standard based encryption 210, photo capture 211, video capture 212, audio capture 213, GPS 214, Serial or USB connectivity 215, ranging device 216, and date/time stamping 217.

In another example the CED, the time and date is logged or recorded via an internal clock mechanism when the device acquires or captures RIS. In this example, the time is presented in the CED at all times. The time is provided in a tamper resistant format on the digital or analog file produced by the CED. In the example of documenting an event or item, providing the time is a useful record that the event took place in case it is ever disputed.

In another example, the CED provides a digital testimony of the location for added ownership verification and certification. An example uses Global Positioning System (GPS) to determine the exact location of the client when the inventory takes place. This example inputs the location coordinates into the documentation in a tamper evident format.

### EXAMPLE

### Device Delivered to Inventory Service

In one example, the consumer delivers the CED to eProoft to provide processing and certification. In this example, the file storage captured or acquired is located within the CED on some standard media such as a hard disk drive or a form of flash media. When eProoft receives the CED, they then handle the downloading of images, processing, and production in house. The device is then reset so that it is available for the next customer.

In another example, the client may upload the data to a remote service center via numerous methods including PC transfer and upload via internet 220, or upload via modem 220. Modem upload is capable of being implemented using either a standard phone port 223 connector or wireless cellular communication 224 technology such as Bluetooth™. PC transfer is implementable via standalone wireless home networking connection 225 capability or via a standard PC port such as Serial or USB connection 215. Once received at the remote service center, licensed eProoft technicians will then take over the processing of the images and production of the finalized file or DVD via the eProoft production method 110 previously described. These uploads may be large in size, so the timeframe in which they can be completed is left up to the client's discretion featuring the capability to pause the transfer while in progress and resume again later.

In some examples, a ranging capability may be established for the device based on existing customer wireless devices such as a telephone base station, a television remote, or a garage door opener. In this example, an global position may not be obtained, but a signal is provided to establish that the image acquisition was conducted within a limited range of a customer wireless device.

### DETAILED DESCRIPTION OF EMBODIMENT

### Certified Event Device (CED) Attachment to Camera or Cell Phone

In this example, a device is provided that may be attached to a customer's camera or picture capable cellular phone. The device may include hardware and software features as described above that interact with the client's aforementioned device in such a way that it allows it to be used to capture the images while still maintaining integrity of certification.

### EXAMPLE

### Customer Sends Data to Inventory Service

In one example, the customer sends data generated using the CED attachment to eProoft to process and certify. An example of this technique uses a device such as a Bluetooth™ capable cellular phone for transmission over the telephone network or by using the client's PC as a conduit between the device used in the process and the remote service center by uploading via the internet as described in the above embodiment.

Kiosk Upload of Data

In this example, the consumer uses kiosk to upload data. This technique provides a way to input data into the kiosk privately while not having to deal with bandwidth limitations that may be present using either a standard telephone or a cellular telephone network. The images are uploaded to the kiosk using a standard port or flash memory reader which is compatible with the camera or cell phone used in the process, and the kiosk features a dedicated high speed connection to the remote service center. Once the client is done uploading to the kiosk and leaves, the kiosk will handle the rest of the task of insuring that the data is received at the remote service center without any further user interaction.

### EXAMPLE

### Attachment Device Serves as Permanent Record

In this example, the attachment device is retained as the primary data storage, or as a backup. In some cases, the attachment may be sent to an escrow service to establish a chain of custody as further proof of authenticity.

### DETAILED DESCRIPTION OF EMBODIMENT

### Appraisals

The inventory service provider may offer additional appraisal services to its customers. The appraisals may be conducted by service provider employees or contractors, but is more typically provided through third party appraisers.

In one example, the customer contracts for regular updates to appraisals of important inventory items. These updates can be provided from the digital inventory, and the results can be forwarded to the customer.

One useful set of information that can be used for appraisals is the actual sales price of items on an auction service such as eBay™. A search engine may be used to detect and retain images of items sold in the online auction environment over a period of time. This information is useful for approximation purposes.

In one embodiment of the current invention, the service provider offers an online appraisal service, which determines an appraised value for inventory items. In this example, eProoft authenticates DIS images through an on-line appraisal service. This service provides an affordable remote method of appraising certain valued assets through photographs. The service provides consumers with a certified digital testimony of assets, documented securely.

In some cases information about an item may be obtained from the image serializer output, or from image metadata, or from a watermark.

One obstacle to the appraising items remotely, such as online, has been the difficulty in obtaining certified images of the asset being appraised. Online appraisers do not normally act at authenticators because of the difficulty of proving the validity of the images submitted. eProoft offers certification of the images used in DIS, conducted and controlled by licensed and bonded professionals. Combining these two, eProoft can offer an online appraiser a certified image, making authentication more practical.

In one example, the appraisal procedures conform to the Uniform Standard of Professional Appraisal Practice (USPAP), which was authorized by the United States Congress as the source of appraisal standards and appraiser qualifications. An appraiser, who is licensed under the USPAP, can make appraisals that hold up in courts of law and in the eyes of the Internal Revenue Service for determining value.

In another embodiment, another appraisal service, such as Ask the Appraiser™, (www.asktheappraiser.com) can be used. This service implements the USPAP 2005 standard. The consumer submits a digital image to the appraiser. A fee is charged according to the item being appraised, with a standard estimate of $9-$10 per item.

Another example of an appraisal service is disaster appraisal service, such as in the aftermath of a tragic event where the consumer lost everything and no predetermined replacement value was given to the items. Rather than waiting for long insurance claims reimbursement procedure an appraisal can be determined by the image alone. In some cases, in may not be necessary for the item to be seen by the appraiser for an appropriate value to be established.

### DETAILED DESCRIPTION OF EMBODIMENT

### Item Identification

Individual item identification is useful for inventory applications and for security applications such as establishing ownership of a particular item.

Bar Coding

Bar coding is one method of establishing communication. In one example, a bar code printer or scanner combination so that labels may be attached and scanned. In this example, the item can be scanned and an existing UPC code or a new label may be used to identify the item. In the case of a new label, the unique identifier is assigned to the corresponding entry in the inventory database.

Other Identification Techniques

Other examples of identification techniques are using devices such as SmartWater™, Radio Frequency Identification Devices RFID or MicroDot™ technology to provide a unique identification for items. The identification methods can be used for consumer security system or surveillance system providing a useful monitor of items. This technique also presents the consumer the ability to monitor their assets from a remote device such as a cell phone or iPod.

In one example, unique codes are identifiable as being produced by eprooft, and these codes provide a unique identification of the client and item. This confidential information may be stored with the client's file and with eProoft in a secure manner.

Metadata

In one example, each metadata is given key code identifiers that are unique to consumer and eProoft.

In another example, the metadata is searchable in relation to the consumer to find certain events or items that have been documented previously. This example is used for easy searching capabilities within an inventory list.

In one example, the consumer has the ability to release information of the metadata content of any stolen or lost assets like brand, model numbers, serial numbers, etc. to an object or item watching service like search engines used by law enforcement agencies or anyother regulatory body's means for searching for missing items. eProoft certifies watermark correlating to metadata content like serial numbers or tags on the physical item to the customer unique ID source code for monitoring and retrieving purposes. This is an example of correlating watermark or inventory tags to the digital images metadata including serial number, marks, description or other codes for purposes of property owner identification. This example is making digital links to physical records for identification provides consumer with double protection. Valuable items are extensively captured with close-ups of serial numbers or markings for further verification.

### DETAILED DESCRIPTION OF EMBODIMENT

### Digital Voice Recorders

In this embodiment, one or more digital voice recorder is used to support the inventory services and other services. A voice recorder and voice recognition software may be used to offer the consumer a way to input data such as stories or last testimonies. This example may use watermarks present in voice recorded data. This technique provides ownership and security when digital content is processed or transcribed.

### DETAILED DESCRIPTION OF EMBODIMENT

### Franchise Business Model

In this embodiment, a franchise business model is used to support the expansion of services to different geographic areas. In one example, eProoft is a franchisor, which provides branding, technological know-how, specialized software, patent and technology licensing, and training to its franchisees. The franchiser may also offer discounts on computers and other equipment. In one example, the franchise model is used to establish a wide service area so that an insurance company can recommend the franchise to its clients.

In one example, the service provides source code, user manuals, reference manuals, Preclaim Specialist™ training procedures and documents, and user interface documentation and screenshots to be held by a third party escrow service. The escrow arrangement permits access to the materials in the event that the franchisor is not able to support the franchisee. The escrow materials may include product definition documents, design documents, and abandoned design documents.

### DETAILED DESCRIPTION OF EMBODIMENT

### Strategic Alignment with Security Services Company Business Model

In this embodiment, the inventory service provider has a strategic partnership with an established entity such as a security services company. The established partner preferably has a trusted relationship with its customers, an excellent reputation, and a widespread geographical presence. One difficulty with growing an inventory service business from a single location to other locations is the need to have additional personnel. The franchise business model is one approach to the growth challenge. Another approach is to partner with an established company in a complimentary service business. One advantage to security service business is that it is mutually complimentary to an inventory services business. Security services customers are already aware of the need to protect their assets, and are likely to use an inventory service for loss risk management. Inventory services customers are likely to discover that they have more assets than they realized, and are likely to consider additional security services to protect those assets.

### DETAILED DESCRIPTION OF EMBODIMENT

### Individual Item Security

In one example of item security is presented in the form of metadata for tagging. This example provides a way to give consumer approximate value, description, sequencing and identifying on an item or asset. In another example, the consumer is presented a technique to monitor assets and inventories by inputting or plugging metadata into their security systems. An example of this method is presented through use of a licensed software that helps the consumer keep current track and record of inventory.

Examples for Metadata Input

In one example, the metadata can be manual typed in by a technician or Preclaim Specialist.

In another example of adding metadata voice recording descriptions or stories can be linked to and stored within metadata of a certified digital image. This technique uses solid metadata patterns and key codes provide identifiers to consumer and image watermark or certification.

Example of Metadata Output

In one example, the consumer presents output of information by releasing their metadata of any stolen or lost item. In this example, the record of metadata is made public by the consumer releasing information content such as brand name, model numbers and serial numbers to an item providing output to a watching service. This method uses law enforcement or regulatory body's search engines for using a full potential means of searching for stolen or missing items. eProoft certifies watermarks providing correlation of property owner identification to the metadata content such as serial numbers or tags on the physical item to the customer for monitoring and retrieving purposes. This example provides way of making digital links to physical records for identification provides consumer with double protection.

### DETAILED DESCRIPTION OF EMBODIMENT

### Inventory Monitoring Before and After a Move

In this embodiment, the DIS is used to monitor key assets before and after a move of items, such as by a moving service.

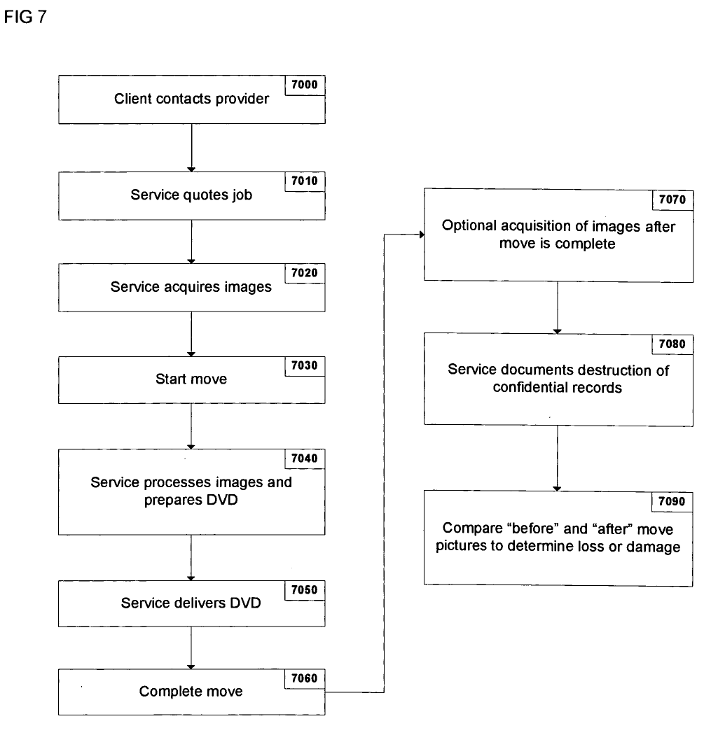

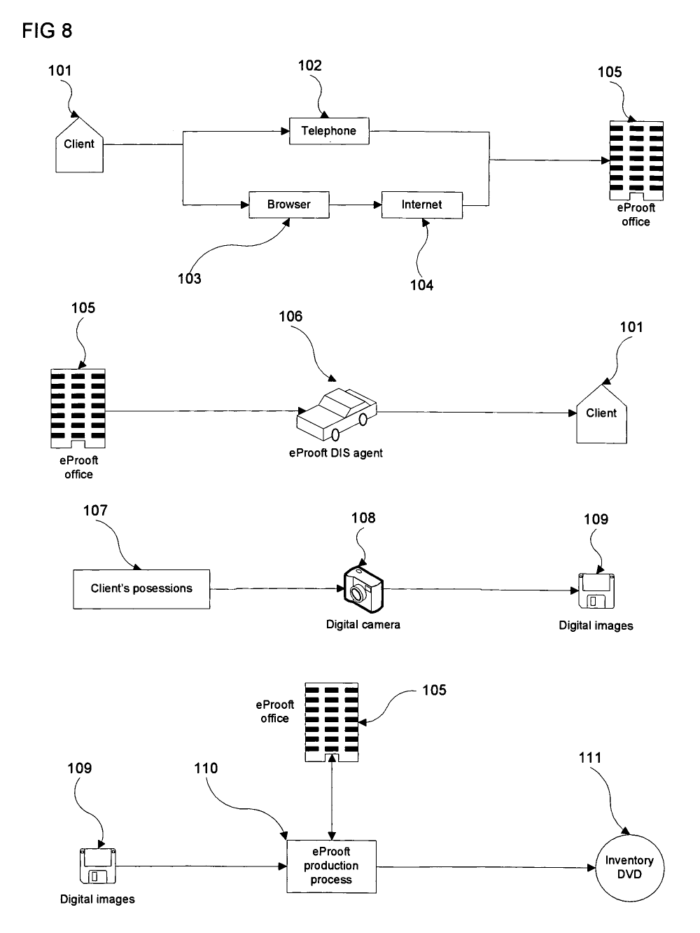

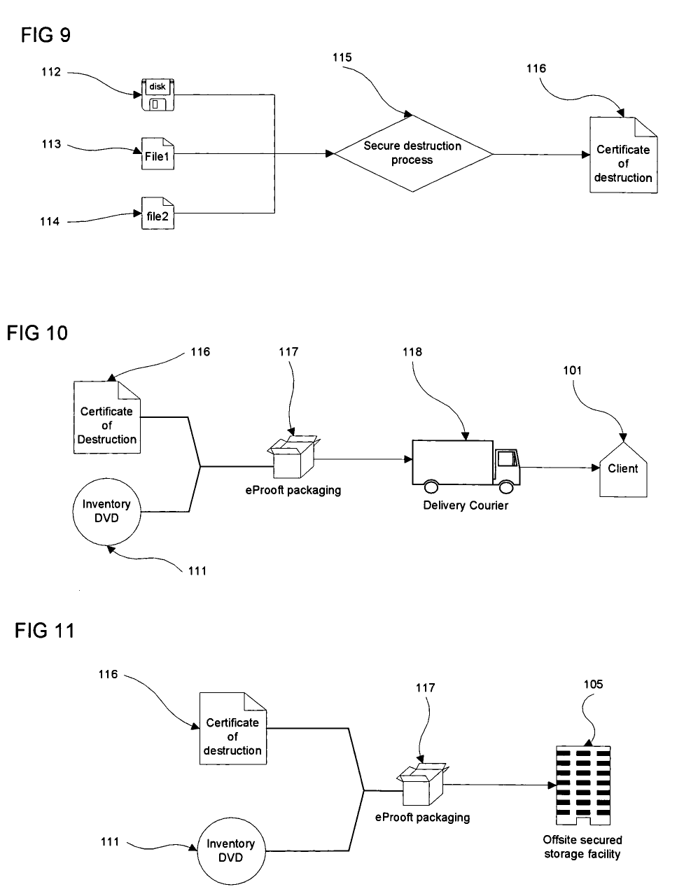

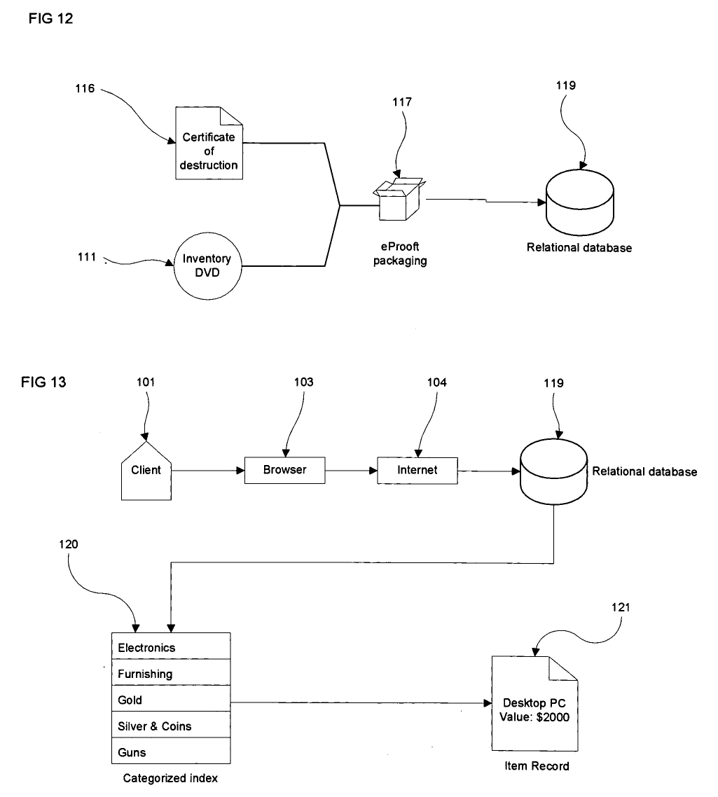

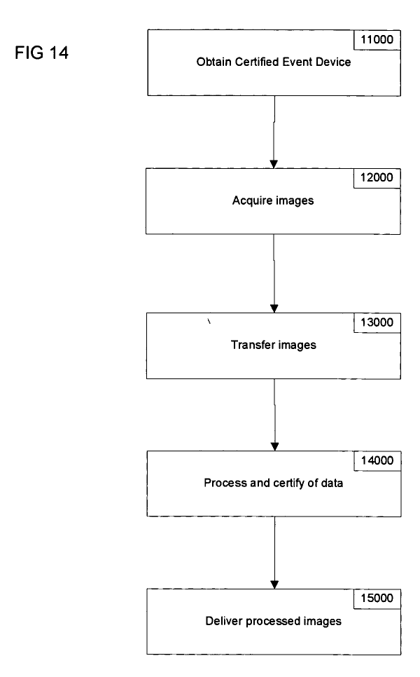

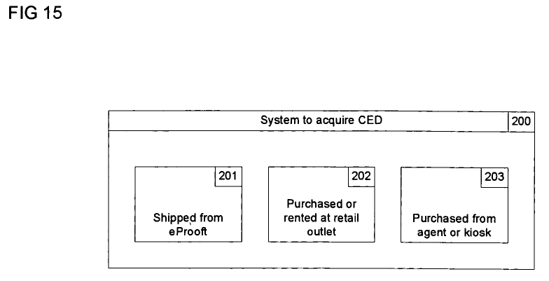

FIG. 7 is a flowchart describing the broad steps in a moving certification process.

At step 7000, the process is initiated. The process may be initiated by a client contacting a DIS service provider, by a moving company contacting a DIS service provider, or by the moving company licensing the DIS technology and providing the service to a moving customer.

At step 7010, the provider quotes the job based on the level of service requested by the client. In one example, the client may desire to document only a few valuable items. In another example, the client may desire to document most items in a house or business in a manner similar to the basic DIS service.

At step 7020, the service provider acquires images of the inventory items before a move.

At step 7020, the move is started. At step 7060, the move is completed. At step 7070, the service provider, optionally acquires a set of images after move is complete.

At step 7040, the provider processes images and prepares a DVD or other format. At step 7050, the provider delivers the DVD or other file format to the customer. Typically, the DVD will be hand-delivered or mailed. In other embodiments, the images may be sent electronically to the customer.

At step 7080 the customer can compare the presence and condition of items “before” and “after” the move to determine loss or damage. The customer may either compare the actual items to the “before” images, or may compare the “before” and “after” images, if images were obtained after the move.

At step 7090, the provider provides an optional certificate of destruction for the client images and records.

In this embodiment, benefits for the client include an assurance that all key items are accounted for, and that those items have not been damaged during the move. In the event that a loss claim should be presented to the moving company, the digital record provides support for that claim.

Benefits for the moving company include the ability to determine that a damaged item had not been damaged prior to a move. Other benefits to the moving company include additional care to important items, and improved customer relations.

The inventory pictures may be plugged into the device in vehicle, such as a moving van, where images are sent to headquarters to be classified and documented.

### DETAILED DESCRIPTION OF EMBODIMENT

### Documenting Estates and Heirship

In this embodiment, the DIS is used to monitor key assets of an estate before and after asset distribution. In this example, a pictorial display is presented for bequeaths to heirs of special items or heirlooms.

In another example, asset inventories for Last Will and Testament as to the distribution of property. This technique can be presented by a recorded or videoed interview of the client making their testimony providing that all assets documented are solely theirs, along with signed affidavit documentation.

### DETAILED DESCRIPTION OF EMBODIMENT

### Documenting Marital Property

In this embodiment, the DIS is used to document the marital property of a spouse, such as in a prenuptial agreement or a second marriage.

### DETAILED DESCRIPTION OF EMBODIIENT

### Digital Inventory Service Intranet Database

In one example of providing server capabilities to the consumer for DIS database and backup same as the internet example described above, except intranet consumer must be provided with a cable box or router device that connects them to a very secure and clean. This example of file storage networking is the most secure example, but is high cost.

### DETAILED DESCRIPTION OF EMBODIMENT

### Inventory Scanning Machine

In this embodiment, a scanner is provided in order to digitize receipts, deeds, existing photographs, and other documents related to inventory items.

### DETAILED DESCRIPTION OF EMBODIMENT

### Integrity of Codes

In one example integrity of key codes is based on secure storage provided by eProoft and proprietary, only allowed accessible by consumer or if need be regulatory services at the discretion of the consumer. An example of this tool presented to identify codes, is used in similar technology to track theft. This method can be extrapolated to non-barcode technologies for a tool used to identify codes.

Another form of Certification is through a technician or Preclaims Specialist provides a Notarization that images were acquired at a time and place.

Techniques of Certification Integrity

In one example of a certification method, is done by certification through acquiring or capturing images. In another example, certification is insured through the processing of the digital images. In another example, certification is upheld through the delivery of the media format. In another example, the consumer is insured certification through file storage location.

What is claimed is:

1. A system for acquiring, selecting, organizing, and certifying a plurality of digital images in order to provide tamper-evident digital image documentation of residential and business assets, the system comprising:
an image capture device for capturing a plurality of digital images;
a computer,
at least one computer program for organizing, and certifying at least a portion of the plurality of digital images and producing a set of certified images, the program comprising:
an image serializer, and
a first image security feature comprising a watermarking tool.

2. The system of claim 1 further comprising:
a storage means for storing the set of certified images.

3. The system of claim 2 wherein the a storage means for storing the set of certified images comprises:
a DVD.

4. The system of claim 2 wherein the a storage means for storing the set of certified images comprises:
an electronic file stored on the computer.

5. The system of claim 1 further comprising:
a second image security feature comprising a tool for encrypting information.

6. The system of claim 1 further comprising:
a second image security feature comprising a tool for scrambling content.

7. The system of claim 1 further comprising:
a second image security feature comprising a tool for providing keycodes in image metadata.

8. The system of claim 1 wherein the image capture device further comprises:
a means for capturing a plurality of still images, and
a means for capturing a plurality of video images.

9. The system of claim 1 further comprising:
at least one fixture to support an inventory item while its image is captured.

10. A method for acquiring, selecting, organizing, and certifying a plurality of digital images in order to provide tamper-evident digital image documentation of residential and business assets of a customer, the method comprising:
capturing a plurality of images with an image capture device;
processing the plurality of images on a computing device, the processing comprising:
reviewing the plurality of images,
selecting a set of desired images from the plurality of images,
serializing the set of desired images into a serialized set of images,
providing a first image security feature for the serialized set of images, and
categorizing the serialized set of images to produce a set of processed images; and
delivering the set of processed images to the customer.

11. The method of claim 10 wherein delivering the set of processed images to the customer further comprises:
delivering a DVD to the customer, the DVD containing the set of processed images.

12. The method of claim 10 wherein providing a first image security feature for the serialized set of images further comprises:
providing at least one digital watermark on the set of images.

13. The method of claim 10 further comprising:
providing a second image security feature for the serialized set of images, the second image security feature selected from the set consisting of
a tool for encrypting information,
a tool for scrambling content, and
a tool for providing keycodes in image metadata.

14. The method of claim 10 wherein capturing a plurality of images with an image capture device further comprises:
capturing a plurality of still images; and
capturing at least one video image.

15. The method of claim 10 wherein capturing a plurality of images with an image capture device further comprises:
providing a first fixture to support an inventory item while its image is captured.

16. The method of claim 10 further comprising.

17. The method of claim 10 further comprising:
capturing additional data related to an image in the plurality of images;
providing a first image security feature for the subsequent image; and
appending the subsequent image, with the first image security feature, to the set of processed images.

18. The method of claim 17 further comprising:
providing, as the additional data, at least one document related to an item in the image.

19. The method of claim 17 further comprising:
providing, as the additional data, a digital testimony of the customer relating information about an item in the image.

20. A method of updating an inventory, the method comprising:
capturing a plurality of images with an image capture device;
processing the plurality of images on a computing device, the processing comprising:
reviewing the plurality of images,
selecting a set of desired images from the plurality of images,
serializing the set of desired images into a serialized set of images,
providing a first image security feature for the serialized set of images, and
categorizing the serialized set of images to produce a set of processed images;
delivering the set of processed images to an escrow agent at a first time;
capturing at least one subsequent image at a second time, the second time later than the first time;
obtaining the set of processed images from the escrow agent;
providing a first image security feature for the subsequent image; and appending the subsequent image, with the first image security feature, to the set of processed images.
